(19) United States
(12) Patent Application Publication
(10) Pub. No.: US 2019/0262221 A1
(43) Pub. Date: Aug. 29, 2019

(54) Facial Roller

(71) Applicant: Lucinni Bailar, Houston, TX (US)

(72) Inventor: Lucinni Bailar, Houston, TX (US)

(21) Appl. No.: 15/906,281

(22) Filed: Feb. 27, 2018

(51) Int. Cl. A61H 15/00; A61H 7/00

(52) U.S. Cl. CPC A61H 15/0085; A61H 2015/0028; A61H 2201/1215; A61H 7/005

(57) ABSTRACT

The facial roller is an apparatus that stimulates blood flow from the inner layer of skin to the outer layer of skin of a face. The apparatus pushes the outer layer into the inner layer, filling in gaps between the outer layer and the inner layer. The apparatus includes an elongated handle, an adapter, a differential, at least one roller, a motor, a power source, and a power switch. The elongated handle houses the adapter, the motor, and the power source. The adapter connects the differential and the at least one roller to the elongated handle. The motor rotates the at least one roller with the differential. The at least one roller applies pressure to the outer layer of skin. The power source provides the necessary power to the motor. The electrical connection is controlled by the power switch.

### FIELD OF THE INVENTION

The present invention generally relates to facial rollers. More specifically, the present invention is a facial roller that facilitates the filling of cavities within the skin.

### BACKGROUND OF THE INVENTION

At-home spa products allows many individuals to improve skincare and overall wellbeing at home and at a lower cost. One of the most common type and favored at-home spa products focus on facial skincare. This is because aging, regardless if an individual is 25 or 50, reduces the firmness of the skin. The outer layer of skin receives less blood flow and nutrients from the lower layer of skin of the face. Gaps between the outer layer of skin and the lower layer of skin increase. The prevention and reduction of appearance of aging requires direct action against the outer layer of skin.

It is therefore an objective of the present invention to stimulate blood flow and the delivery of nutrients between the lower layer of skin and the outer layer of skin of the face. The present invention accommodates varying types of skin. The present invention maximizes the stimulation of the outer layer of skin with circular motion. The present invention is a portable device that allows a user to easily maneuver across the face. Moreover, the present invention effectively encourages oxygen to flow through the outer layer of skin of the face.

### BRIEF DESCRIPTION OF THE DRAWINGS

FIG. 1 is a front perspective view of the preferred embodiment of the present invention, wherein each of the at least one roller comprises a plurality of ridges.

FIG. 2 is a right side view of the preferred embodiment of the present invention.

FIG. 3 is a top side view of the preferred embodiment of the present invention.

FIG. 4 is a front side view of the preferred embodiment of the present invention.

FIG. 5 is a front perspective view of an alternate embodiment of the present invention with at least one roller and at least one supplementary roller.

FIG. 6 is a top side view of the preferred embodiment of the present invention with at least one roller and at least one supplementary roller.

FIG. 7 is a front perspective view of the preferred embodiment of the present invention, wherein each of the at least one roller comprises a plurality of bristle clusters.

FIG. 8 is a front perspective view of the preferred embodiment of the present invention, wherein each of the at least one roller comprises a plurality of flaccid protrusions.

FIG. 9 is a schematic view of the electrical connections of the present invention.

FIG. 10 is a schematic view of the plurality of ridges of the at least one roller of the present invention.

FIG. 11 is a schematic view of the differential of the present invention.

### DETAIL DESCRIPTIONS OF THE INVENTION

All illustrations of the drawings are for the purpose of describing selected versions of the present invention and are not intended to limit the scope of the present invention.

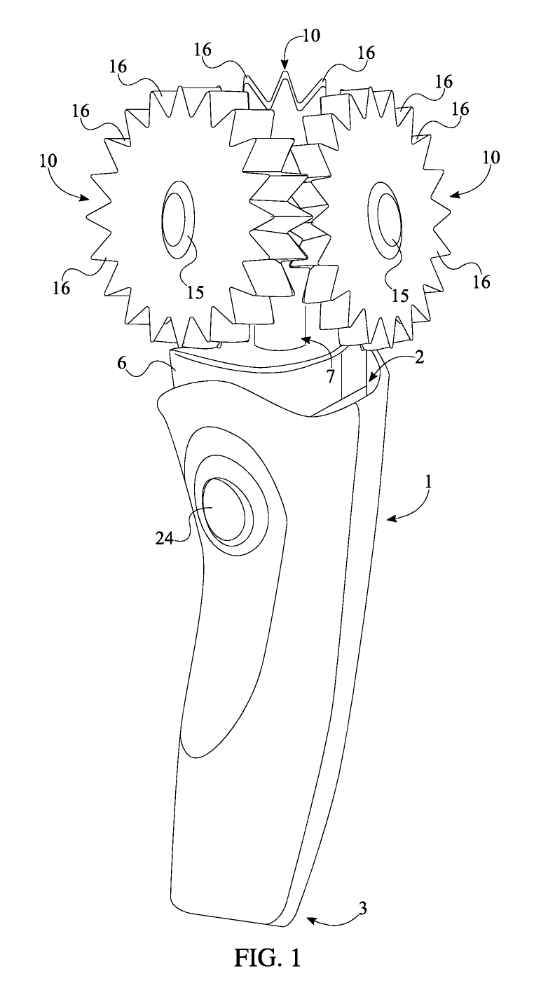

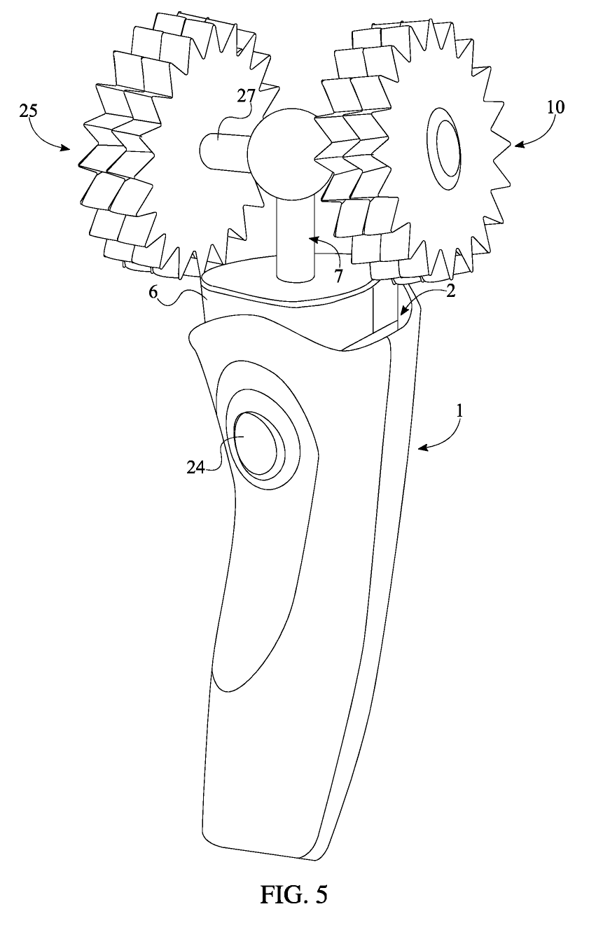

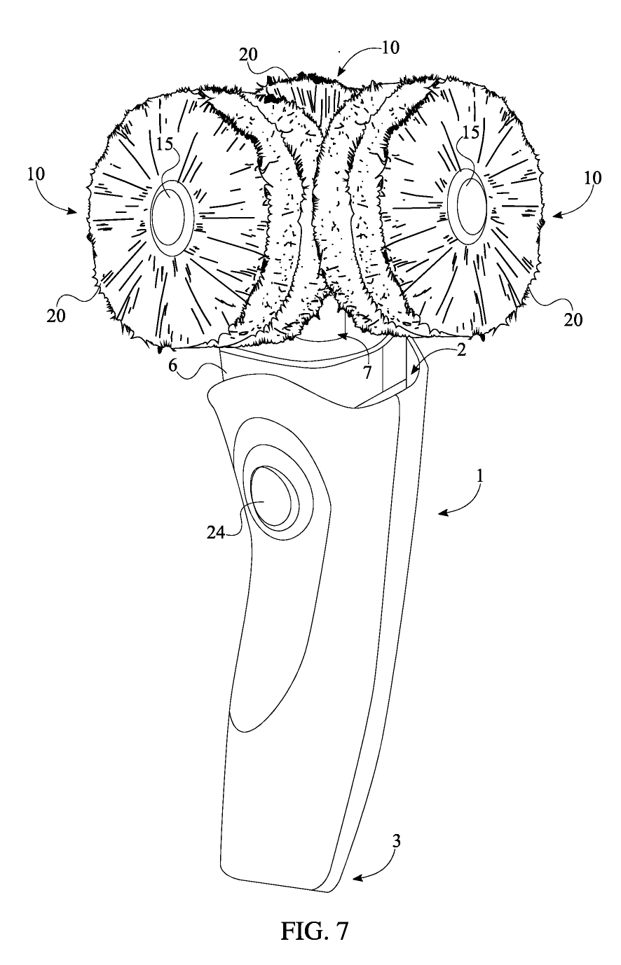

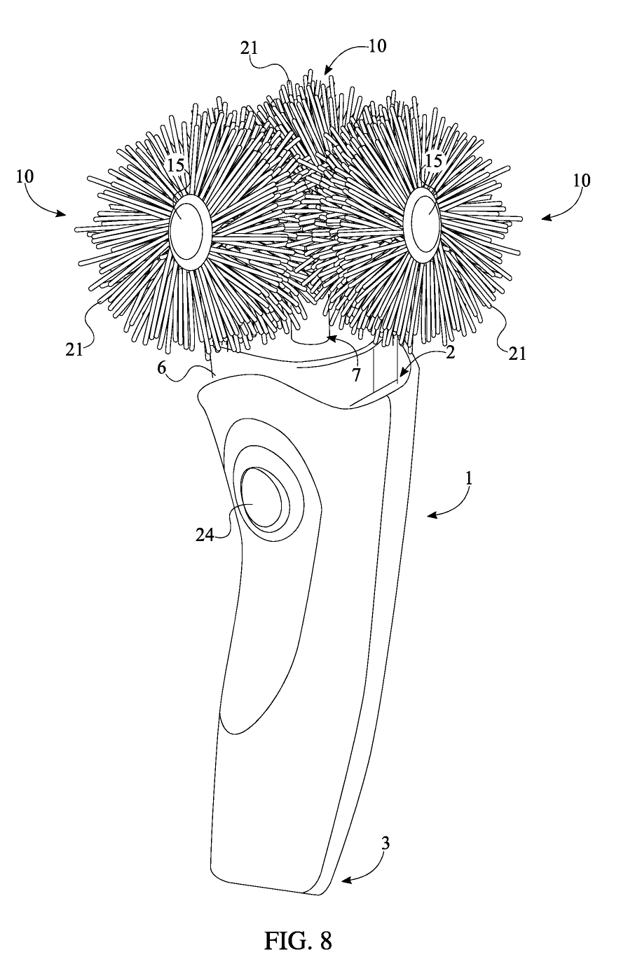

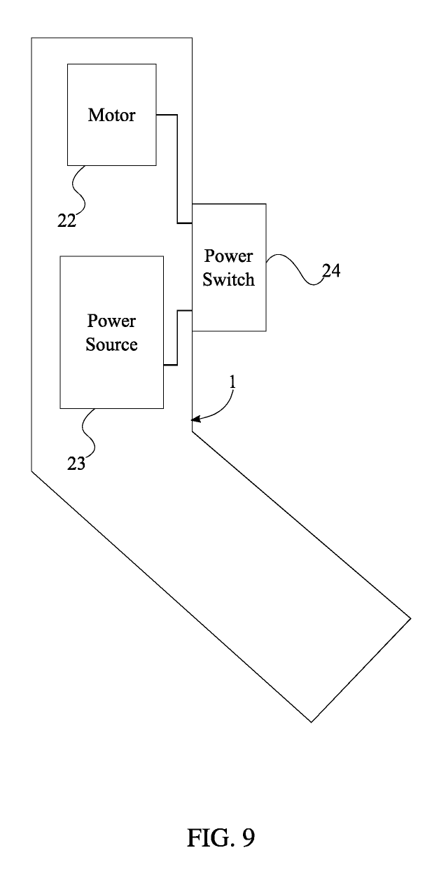

The present invention is a facial roller that suppresses the outer layer of skin into the lower layer of skin of the face. The present invention facilitates the delivery of nutrients that are found in the lower layer of skin to the outer layer of skin. In order for the present invention to stimulate the blood flow within the layers of skin of the face, the present invention comprises an elongated handle 1, an adapter 6, a differential 7, at least one roller 10, a motor 22, a power source 23, and a power switch 24, seen in FIG. 1, FIG. 5, FIG. 7, FIG. 8, and FIG. 9. The elongated handle 1 houses the adapter 6, the differential 7, the motor 22, and the power source 23. The elongated handle 1 allows a user to maneuver the at least one roller 10 across the outer layer of skin of a face. The elongated handle 1 comprises an open end 2 and a closed end 3. The open end 2 allows the adapter 6 to mount the differential 7 onto the elongated handle 1, and consequently stabilize the at least one roller 10. The closed end 3 conceals and encloses the motor 22 and power source 23 within the elongated handle 1. The adapter 6 connects the differential 7, and consequently the at least one roller 10, to the elongated handle 1. The differential 7 translates the rotation of the motor 22 to the at least one roller 10, thereby allowing the rotation of the at least one roller 10 to be controlled by the motor 22. The at least one roller 10 applies pressure to the outer layer of skin and pushes the outer layer of skin against the lower layer of skin. Moreover, the motor 22 rotates the at least one roller 10 through the differential 7. The power source 23 provides the necessary power to the motor 22. The power switch 24 connects and disconnects the electrical connection between the power source 23 and the motor 22, allowing the user to manually control the rotation of the at least one roller 10.

The overall configuration of the aforementioned components allows the present invention to automatically deliver continuous pressure against the outer layer of skin of a face in a circular motion. In order for the present invention to be easily maneuverable across a face, the motor 22 and power source 23 are mounted within the elongated handle 1, as shown in FIG. 9. The at least one roller 10 is connected as the adapter 6 is attached adjacent to the open end 2. The at least one roller 10 is rotated as the differential 7 is mounted into the adapter 6, opposite the elongated handle 1, and the at least one roller 10 is torsionally connected to the motor 22 through the differential 7. A rotation axis 11 of the at least one roller 10 is oriented perpendicular to a normal direction of the open end 2, comfortably orienting the grip of the user while the at least one roller 10 rotates and presses against the face. The power switch 24 is laterally mounted to the elongated handle 1 such that the position of the power switch 24 is adjacent the thumb of the grip of the user, facilitating the control of the power source 23. The power source 23 is electrically connected to the motor 22 through the power switch 24. Alternate embodiments of the present invention may comprise a speed-control button that increases and reduces the speed of rotation of an axle of the motor 22.

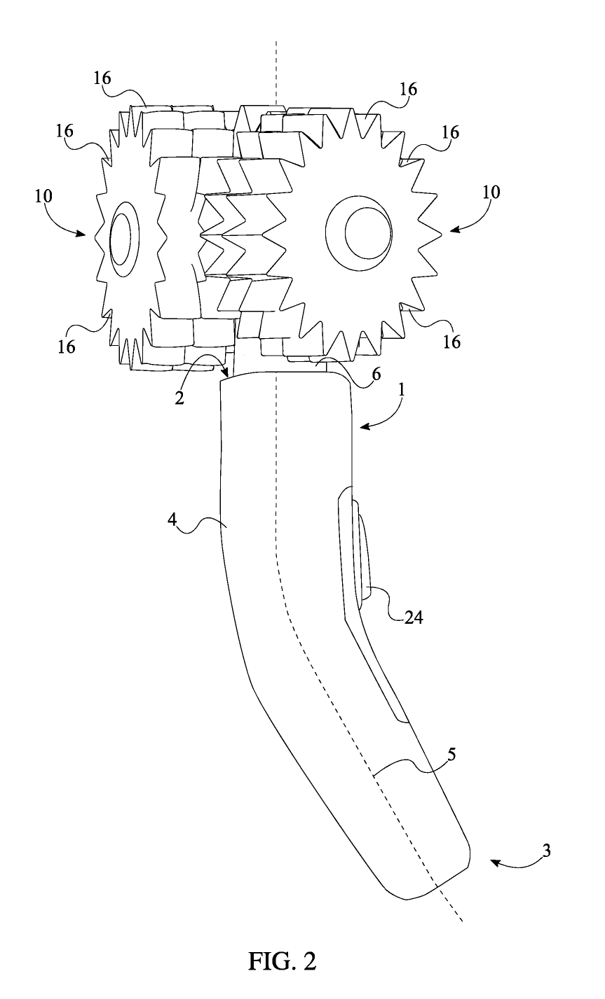

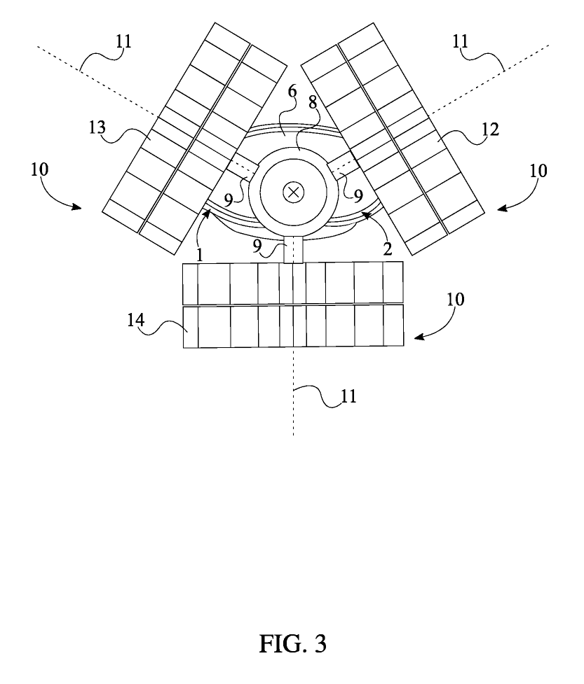

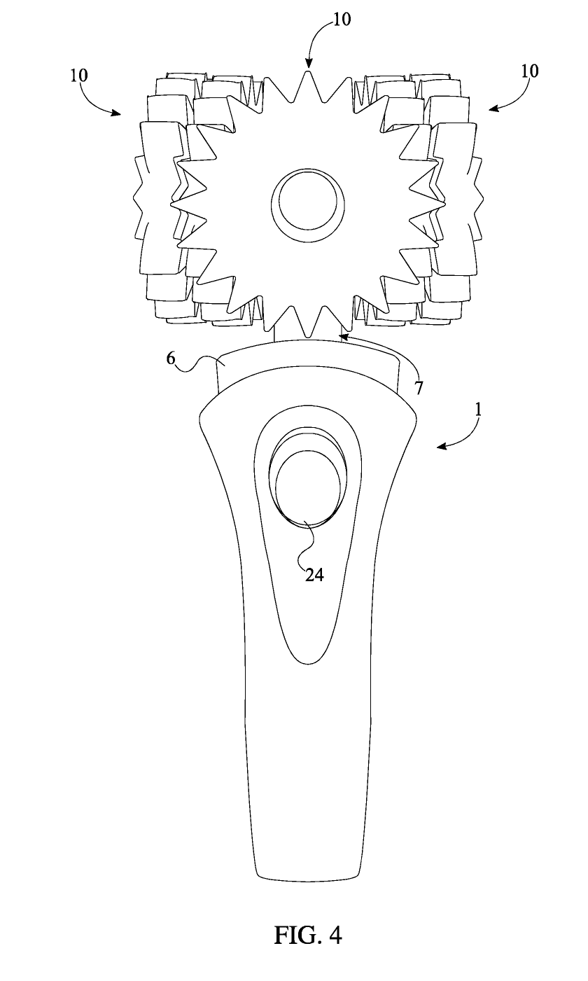

In the preferred embodiment of the present invention, shown in FIG. 1, FIG. 2, FIG. 3, and FIG. 4, the at least one roller 10 comprises a first roller 12, a second roller 13, and a third roller 14. The first roller 12, the second roller 13, and the third roller 14 are radially distributed about the differential 7. This arrangement simultaneously applies pressure to the more surface area of the face. Furthermore, this arrangement facilitates the continuous and circular movement of at least one roller 10 across the face.

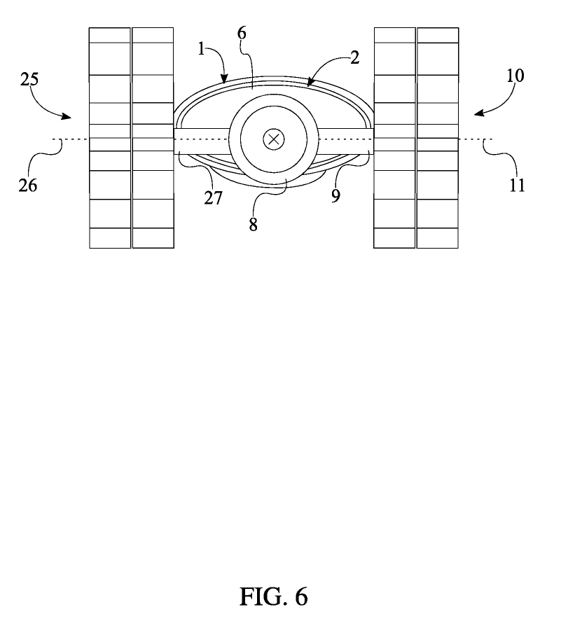

An alternate embodiment of the present invention, shown in FIG. 5 and FIG. 6, comprises at least one supplementary roller 25 and an offset shaft 27. The at least one supplementary roller 25 is torsionally connected to the at least one roller 10 by the offset shaft 27 so that the at least one supplementary roller 25 rotates in unison with the at least one roller 10. More specifically, the offset shaft 27 is positioned in between the at least one supplementary roller 25 and the at least one roller 10. A rotation axis 26 of the at least one supplementary roller 25 is colinear with the rotation axis 11 of the at least one roller 10. This arrangement encourages linear paths across the face. Linear paths across the face facilitate the removal and prevention of wrinkles and encourage the lifting of facial muscles.

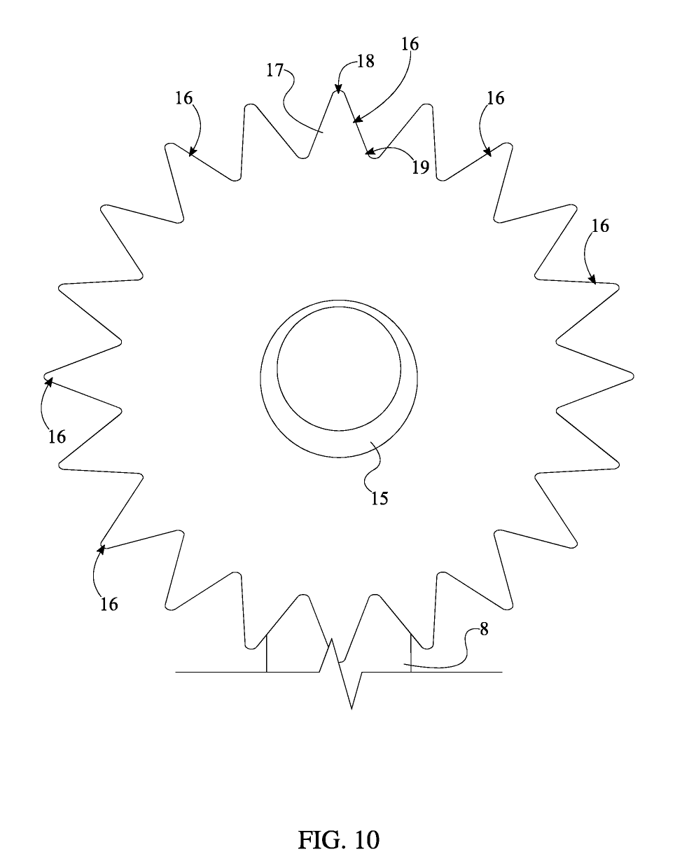

In order to accommodate a more rigid and tough outer layer of skin of a face, the at least one roller 10 comprises a cylindrical body 15 and a plurality of ridges 16, also seen in FIG. 1, FIG. 2, FIG. 3, and FIG. 4. The cylindrical body 15 allows the plurality of ridges 16 to smoothly rotate against the outer layer of skin of the face. The plurality of ridges 16 delivers a blunt and strong force against the outer skin of the face. The plurality of ridges 16 is laterally connected around the cylindrical body 15 and is radially distributed about the cylindrical body 15. This arrangement allows the plurality of ridges 16 to continuously press against the outer layer of skin of the face while the cylindrical body 15 rotates. In the preferred embodiment of the plurality of ridges 16, each of the plurality of ridges 16 comprises a protruding body 17, a proximal end 18, and a distal end 19, as seen in FIG. 10. The protruding body 17 tapers from the distal end 19 to the proximal end 18. Moreover, the distal end 19 is laterally connected to the cylindrical body 15. The tapered structure of the protruding body 17 allows the proximal end 18 to precisely and bluntly apply force to the outer layer of skin of the face.

In order to accommodate a more normal type of outer layer of skin of a face, the at least one roller 10 comprises cylindrical body 15 and a plurality of bristle clusters 20, as seen in FIG. 7. The cylindrical body 15 allows the plurality of bristle clusters 20 to smoothly rotate against the outer layer of skin of the face. The plurality of bristles clusters 20 applies a gentle yet strong force against the outer layer of skin of the face. Furthermore, the plurality of bristles clusters 20 buffers the outer layer of skin while applying force. Similar to the plurality of ridges 16, the plurality of bristle clusters 20 is laterally connected around the cylindrical body 15 and is radially distributed about the cylindrical body 15. This arrangement allows the plurality of bristles clusters 20 to continuously press against the outer layer of skin of the face while the cylindrical body 15 rotates.

In order to accommodate more sensitive outer layer of skin of a face, the at least one roller 10 comprises a cylindrical body 15 and a plurality of flaccid protrusions 21, as seen in FIG. 8. The cylindrical body 15 allows the plurality of flaccid protrusions 21 to smoothly rotate against the outer layer of skin of the face. The plurality of flaccid protrusions 21 applies a gentle and very light force against the outer layer of skin of the face. The plurality of flaccid protrusions 21 very lightly stimulates the blood flow of the sensitive outer layer of skin while minimizing any abrasive contact with sensitive outer layer of skin of the face. Similar to the plurality of ridges 16 and the plurality of bristle clusters 20, the plurality of flaccid protrusions 21 is laterally connected around the cylindrical body 15 and is radially distributed about the cylindrical body 15.

The present invention accommodates the grip structure of the user as the elongated handle 1 further comprises a handle housing 4, as seen in FIG. 2. The handle housing 4 contains and conceals the motor 22 and the power source 23 while providing an ergonomic structure for the present invention. The handle housing 4 tapers from the open end 2 to the closed end 3, thereby defining the ergonomic structure of the present invention. More specifically, a central axis 5 of the elongated handle 1 traverses from the open end 2 to the closed end 3. The central axis 5 of the elongated handle 1 is a curved line. The present invention further accommodates the grip structure of the user as the power switch 24 is centrally positioned in between the open end 2 and the closed end 3, allowing the user to easily turn on and turn off the present invention.

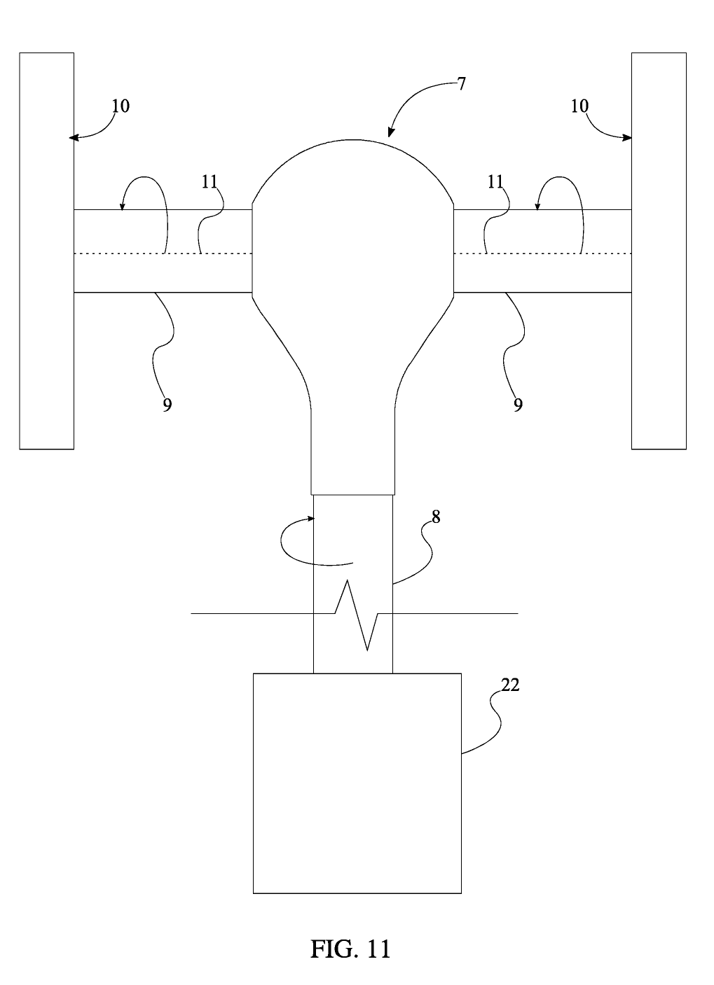

As shown in FIG. 3 and FIG. 11, in order to effectively rotate the at least one roller 10 about the rotation axis 11 with the motor 22 contained within the elongated handle 1, the differential 7 comprises an input shaft 8 and at least one output shaft 9. The input shaft 8 applies the rotation of an axle of the motor 22 to the output shaft 9. The output shaft 9 connects at least one roller 10 to the input shaft 8. In order to rotate the at least one roller 10, the motor 22 is operatively coupled to the input shaft 8, wherein the motor 22 is used to rotate the input shaft 8. The at least one output shaft 9 is positioned perpendicular to the input shaft 8, accommodating the orientation of the rotation axis 11 of the at least one roller 10 with respect to the axle of the motor 22. More specifically, the at least one output shaft 9 is operatively coupled to the at least one roller 10, wherein the at least one output shaft 9 is used to rotate the at least one roller 10.

Although the invention has been explained in relation to its preferred embodiment, it is to be understood that many other possible modifications and variations can be made without departing from the spirit and scope of the invention as hereinafter claimed.

What is claimed is:

1. A facial roller comprises:
an elongated handle;
an adapter;
a differential;
at least one roller;
a motor;
a power source;
a power switch;
the elongated handle comprises an open end and a closed end;
the motor and the power source being mounted within the elongated handle;
the adapter being attached adjacent to the open end;
the differential being mounted into the adapter, opposite the elongated handle;
the at least one roller being torsionally connected to the motor through the differential;
a rotation axis of the at least one roller being oriented perpendicular to a normal direction of the open end;
the power switch being laterally mounted to the elongated handle; and,
the power source being electrically connected to the motor through the power switch.

2. The facial roller as claimed in claim 1 comprises:
the at least one roller comprises a first roller, a second roller, and a third roller; and,
the first roller, the second roller, and the third roller being radially distributed about the differential.

3. The facial roller as claimed in claim 1 comprises:
at least one supplementary roller;
an offset shaft;
the at least one supplementary roller being torsionally connected to the at least one roller by the offset shaft;
the offset shaft being positioned in between the at least one supplementary roller and the at least one roller; and,
a rotation axis of the at least one supplementary roller being colinear with the rotation axis of the at least one roller.

4. The facial roller as claimed in claim 1 comprises:
the at least one roller comprises a cylindrical body and a plurality of ridges;
the plurality of ridges being laterally connected around the cylindrical body; and,
the plurality of ridges being radially distributed about the cylindrical body.

5. The facial roller as claimed in claim 4 comprises:
each of the plurality of ridges comprises a protruding body, a proximal end, and a distal end;
the protruding body tapering from the distal end to the proximal end; and,
the distal end being laterally connected to the cylindrical body.

6. The facial roller as claimed in claim 1 comprises:
the at least one roller comprises a cylindrical body and a plurality of bristle clusters;
the plurality of bristle clusters being laterally connected around the cylindrical body; and,
the plurality of bristle clusters being radially distributed about the cylindrical body.

7. The facial roller as claimed in claim 1 comprises:
the at least one roller comprises a cylindrical body and a plurality of flaccid protrusions;
the plurality of flaccid protrusions being laterally connected around the cylindrical body; and,
the plurality of flaccid protrusions being radially distributed about the cylindrical body.

8. The facial roller as claimed in claim 1 comprises:
the elongated handle further comprises a handle housing;
the handle housing tapering from the open end to the closed end;
a central axis of the elongated handle traversing from the open end to the closed end; and,
the central axis of the elongated handle being a curved line.

9. The facial roller as claimed in claim 1 comprises:
the power switch being centrally positioned in between the open end and the closed end.

10. The facial roller as claimed in claim 1 comprises:
the differential comprises an input shaft and at least one output shaft;
the motor being operatively coupled to the input shaft, wherein the motor is used to rotate the input shaft;
the at least one output shaft being positioned perpendicular to the input shaft; and,
the at least one output shaft being operatively coupled to the at least one roller, wherein the at least one output shaft is used to rotate the at least one roller.

11. A facial roller comprises:
an elongated handle;
an adapter;
a differential;
at least one roller;
a motor;
a power source;
a power switch;
the elongated handle comprises an open end and a closed end;
the differential comprises an input shaft and at least one output shaft;
the motor and the power source being mounted within the elongated handle;
the adapter being attached adjacent to the open end;
the differential being mounted into the adapter, opposite the elongated handle;
the at least one roller being torsionally connected to the motor through the differential;
a rotation axis of the at least one roller being oriented perpendicular to a normal direction of the open end;
the power switch being laterally mounted to the elongated handle;
the power source being electrically connected to the motor through the power switch;
the motor being operatively coupled to the input shaft, wherein the motor is used to rotate the input shaft;
the at least one output shaft being positioned perpendicular to the input shaft; and,
the at least one output shaft being operatively coupled to the at least one roller, wherein the at least one output shaft is used to rotate the at least one roller.

12. The facial roller as claimed in claim 11 comprises:
the at least one roller comprises a first roller, a second roller, and a third roller; and,
the first roller, the second roller, and the third roller being radially distributed about the differential.

13. The facial roller as claimed in claim 11 comprises:
at least one supplementary roller;
an offset shaft;
the at least one supplementary roller being torsionally connected to the at least one roller by the offset shaft;
the offset shaft being positioned in between the at least one supplementary roller and the at least one roller; and,
a rotation axis of the at least one supplementary roller being colinear with the rotation axis of the at least one roller.

14. The facial roller as claimed in claim 11 comprises:
the at least one roller comprises a cylindrical body and a plurality of ridges;
each of the plurality of ridges comprises a protruding body, a proximal end, and a distal end;
the plurality of ridges being laterally connected around the cylindrical body;
the plurality of ridges being radially distributed about the cylindrical body;
the protruding body tapering from the distal end to the proximal end; and,
the distal end being laterally connected to the cylindrical body.

15. The facial roller as claimed in claim 11 comprises:
the at least one roller comprises a cylindrical body and a plurality of bristle clusters;
the plurality of bristle clusters being laterally connected around the cylindrical body; and,
the plurality of bristle clusters being radially distributed about the cylindrical body.

16. The facial roller as claimed in claim 11 comprises:
the at least one roller comprises a cylindrical body and a plurality of flaccid protrusions;
the plurality of flaccid protrusions being laterally connected around the cylindrical body; and,
the plurality of flaccid protrusions being radially distributed about the cylindrical body.

17. The facial roller as claimed in claim 11 comprises:
the elongated handle further comprises a handle housing;
the handle housing tapering from the open end to the closed end;
a central axis of the elongated handle traversing from the open end to the closed end; and,
the central axis of the elongated handle being a curved line.

18. The facial roller as claimed in claim 11 comprises:
the power switch being centrally positioned in between the open end and the closed end.
